(19) United States
(12) Patent Application Publication
(10) Pub. No.: US 2025/0307522 A1
(43) Pub. Date: Oct. 2, 2025

(54) ARTIFICIAL INTELLIGENCE SYSTEM FOR ASSESSING A PRINTED CIRCUIT BOARD DESIGN

(71) Applicant: Sandisk Technologies Inc., Milpitas, CA (US)

(72) Inventors: Tew Wei Hong, Penang (MY); Chun Sean Lau, Penang (MY); Ping Tze Chan, Penang (MY)

(21) Appl. No.: 18/623,599

(22) Filed: Apr. 1, 2024

(51) Int. Cl. G06F 30/398

(52) U.S. Cl. CPC G06F 30/398

(57) ABSTRACT

A printed circuit board (PCB) design analysis system analyzes a PCB design to determine whether the PCB design satisfies various learned PCB design rules. The PCB design analysis system generates and provides recommendations regarding how the PCB design should be modified when it is determined the PCB design breaks one or more of the PCB design rules. In situations in which the PCB design cannot be modified, the PCB design analysis system generates a tooling feature modification recommendation. This recommendation also includes a cost associated with the modification and a time frame required for the modification. The PCB design analysis system also learns how to provide improved recommendations based on received feedback corresponding to previously generated recommendations.

### BACKGROUND

Designing a new layout for a printed circuit board (PCB) is a long and complicated process and typically involves a number of steps. For example, when a new PCB design or layout is designed by a PCB design team, the PCB design is provided to a packaging design engineering team. The packaging design engineering team analyzes the PCB design to determine whether any PCB design rules associated with the packaging design engineering team are violated by the layout in the PCB design. If so, the PCB design is returned to the PCB design team and the process repeats.

When the packaging design engineering team approves the PCB design, the PCB design is provided to a packaging integration engineering team. The packaging integration engineering team analyzes the PCB design against another set of PCB design rules to determine whether any of these rules are violated by the PCB design. If so, the PCB design is returned to the PCB design team and the process repeats.

In some cases, the PCB design is passed to the different engineering teams a number of different times. However, each iteration adds additional time and cost to a PCB fabrication process.

Accordingly, it would be beneficial to reduce or eliminate the back and forth between different engineering teams when a new PCB layout is designed.

### SUMMARY

The present disclosure describes a printed circuit board (PCB) design analysis system that analyzes a PCB design. In an example, the PCB design analysis system receives the PCB design, compares the PCB design to one or more PCB design rules to determine whether one or more of the PCB design rules are violated or broken. Based on the analysis, the PCB design analysis system either approves the PCB design or provides recommendations.

In one example, the recommendation is a proposed modification to the PCB design. For example, the PCB design analysis system generates and provides an updated PCB design in which one or more electronic components on the PCB are moved or are otherwise changed. In another example, the recommendation is a proposed modification to one or more tools or tooling features that will be used with the PCB design and/or will be used with the fabricated PCB. In yet another example, the recommendation is a proposed modification to the PCB design and a modification to one or more tools or tooling features.

In an example, the PCB design analysis system is a self-learning system. For example, the PCB design analysis system utilizes artificial intelligence and/or machine learning to analyze the PCB design and generate recommendations. For example, the PCB design analysis system is provided with PCB design rules, available tools, available tooling designs/features, electrical signal requirements and/or PCB layouts. Using this information, the PCB design analysis system analyzes the PCB design and either approves the PCB layout or provides recommendations. As recommendations and/or approvals are acted on, this information is provided back to the PCB design analysis system. The PCB design analysis system updates its knowledge base using the information.

Accordingly, examples of the present disclosure describe a method that includes receiving PCB design information. The PCB design information is analyzed using a PCB design analysis system. In an example, the PCB design analysis system is trained using one or more PCB design rules. The PCB design analysis system determines, based at least in part, on the analysis, whether to provide a recommendation regarding an update to the PCB design. When the PCB design analysis system determines to provide the recommendation to update the PCB design, the PCB design analysis system also determines whether to provide a first recommendation corresponding to a first PCB design aspect or to provide a second recommendation corresponding to a second PCB design aspect. In an example, the determination as to whether to provide the first recommendation or the second recommendation is based, at least in part, on a PCB design criterion. The PCB design analysis system generates at least one of the first recommendation and the second recommendation and provides the at least one of the first recommendation and the second recommendation to a computing device.

The present application also describes a PCB design analysis system. In an example, the PCB design analysis system includes at least one processor and a memory communicatively coupled to the at least one processor. The memory stores instructions that, when executed by the at least one processor, perform operations. In an example, the operations include receiving a PCB design and analyzing the PCB design using one or more PCB design rules. A determination is made regarding whether to provide a first recommendation corresponding to a first PCB design aspect or to provide a second recommendation corresponding to a second PCB design aspect. In an example, the determination is based, at least in part, on the analysis and on a PCB design criterion. At least one of the first recommendation and the second recommendation is generated and the generated recommendation is provided to a computing device.

Another example describes a system that includes at least one processing means and a PCB design analysis means. In an example, the PCB design analysis means is operable to receive, from a computing device, a PCB design. The PCB design is analyzed using one or more PCB design rules. The PCB design analysis means determines, based at least in part, on the analysis and on a PCB design criterion, whether to provide a first recommendation corresponding to a first PCB design aspect or to provide a second recommendation corresponding to a second PCB design aspect. The PCB design analysis means also generates at least one of the first recommendation and the second recommendation and provides the at least one of the first recommendation and the second recommendation to the computing device.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates a system that includes a PCB design analysis system according to an example.

FIG. 2 illustrates the system of FIG. 1 in which a computing device has provided a PCB design to the PCB design analysis system according to an example.

FIG. 3 illustrates a tooling recipe that is generated by a PCB design analysis system according to an example.

FIG. 4 illustrates a PCB design modification that is included with a recommendation generated by a PCB design analysis system according to an example.

FIG. 5 illustrates a tooling modification that is included with a recommendation generated by a PCB design analysis system according to an example.

FIG. 6 illustrates how a PCB design analysis system uses information in a tooling checklist to determine whether a PCB design is to be modified according to an example.

FIG. 7 illustrates how a PCB design analysis system uses information in a tooling checklist to determine whether a PCB design is to be modified according to another example.

FIG. 8 illustrates how a PCB design analysis system uses information in a tooling checklist to determine whether a PCB design is to be modified according to another example.

FIG. 9 illustrates a method for generating a PCB design recommendation according to an example.

FIG. 10 is a system diagram of a computing device according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. The following detailed description is therefore not to be taken in a limiting sense, and the scope of the present disclosure is defined by the appended claims and their equivalents.

As previously discussed, designing a new layout and/or routing for a printed circuit board (PCB) is a long and complicated process. Typically, the design process involves a number of different steps. Additionally, each step may be handled by different engineering teams. For example, when a new PCB layout is designed by a PCB design team, the PCB design is provided to a packaging design engineering team. The packaging design engineering team analyzes the PCB design to determine whether any PCB design rules associated with the packaging design engineering team are violated. If one or more PCB design rules are violated, the PCB design is returned to the PCB design team and the process repeats.

When the packaging design engineering team approves the PCB design, the PCB design is provided to a packaging integration engineering team. The packaging integration engineering team also analyzes the PCB design against another set of PCB design rules to determine whether any of these PCB design rules are violated. If one or more of these PCB design rules are violated, the PCB design is returned to the PCB design team and the process repeats.

Typically, each time the PCB design is returned to the PCB design team, the PCB design team has a set period of time in which the PCB design needs to be revised. However, due to the complicated nature of PCB design and the different teams that are involved, the PCB design may be subject to time constraints. Upon expiration of the time constraints, the PCB design cannot be modified. If the PCB design can no longer be modified, tooling features may need to be moved and/or modified and/or tools may need to be developed/modified to fabricate the PCB using the final PCB design. However, modifying tools or tooling features increases the cost of PCB fabrication and package assembly.

To address the above, the present disclosure describes a PCB design analysis system. The PCB design analysis system receives a PCB design, compares the PCB design to one or more PCB design rules and determines whether one or more PCB design rules are violated or broken. Based on the analysis, the PCB design analysis system either approves the PCB design or provides recommendations.

In one example, the recommendation is a proposed modification to the PCB design. For example, the PCB design analysis system generates and provides an updated PCB design in which one or more electronic components in the PCB design are moved or are otherwise changed. In another example, the recommendation is a proposed modification to one or more tools or tooling features associated with the PCB design. In yet another example, the recommendation is a proposed modification to circuitry layout and/or routing paths associated with the PCB design. In an example, the proposed modification to the circuitry layout and/or routing paths is based on a determined or desired signal strength. In yet another example, the recommendation includes a modification to the PCB design and a modification to one or more tooling features. In an example, the modifications to the PCB design and the tooling features are generated and provided in a single recommendation or in multiple recommendations.

The PCB design analysis system of the present disclosure utilizes artificial intelligence and/or machine learning to analyze the PCB design and generate recommendations. For example, the PCB design analysis system is provided with PCB design rules, available tools or tooling designs/features, electrical signal requirements and/or PCB layouts. Using this information, the PCB design analysis system analyzes the PCB design and either approves the PCB design or provides recommendations. As recommendations or approvals are acted on, this information is provided back to the PCB design analysis system, which enables the PCB design analysis system to learn and/or update its knowledge base.

Accordingly, many technical benefits may be realized including, but not limited to, reducing or eliminating multiple steps and revisions during a PCB design process and enhancing the reliability of PCBs that are designed and subsequently fabricated.

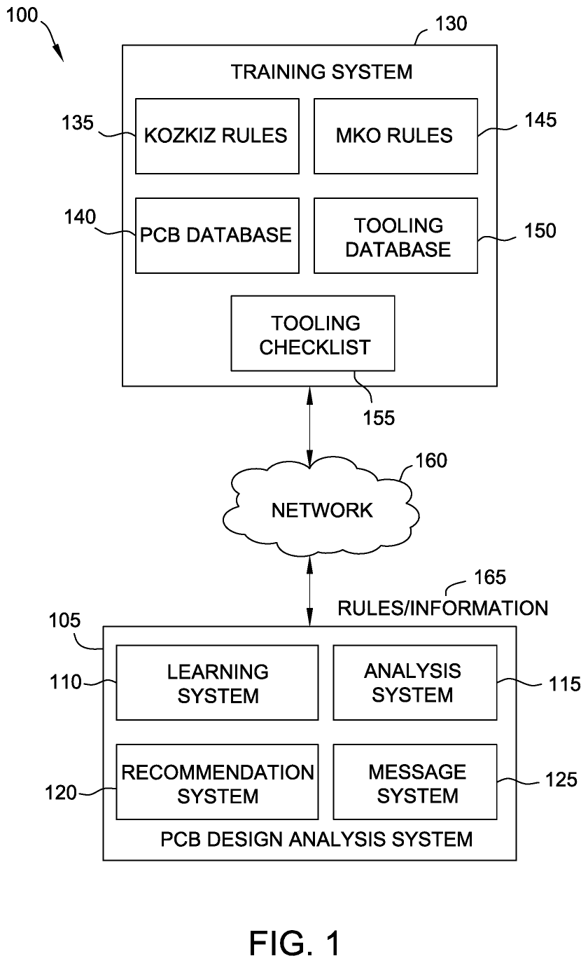

These and other examples will be shown and described in greater detail with respect to FIG. 1-FIG. 10.

FIG. 1 illustrates a system 100 that includes a PCB design analysis system 105 according to an example. In an example, the PCB design analysis system 105 is operable to receive a PCB design (e.g., from a computing device associated with an individual or a PCB design team) and determine whether one or more PCB design requirements are met and/or are not met. If one or more PCB design requirements are not met, the PCB design analysis system 105 generates and provides one or more recommendations. In an example, the recommendations include, but are not limited to, updates to the PCB design including electronic component placement, electronic component size, electronic component type and/or the number of electronic components provided on the PCB. In another example, the recommendations include recommendations regarding the placement and spacing of communication paths (e.g., traces and vias). In yet another example, the recommendations include recommendations regarding modifications to tooling features or tools associated or used with the PCB design.

In an example, the recommendations include any combination of the above. For example, the recommendation includes a modification to the PCB design and a modification to one or more tooling features. When the recommendations are generated, the recommendations are provided to the computing device.

In an example, the PCB design analysis system 105 utilizes artificial intelligence and/or machine learning to determine whether the PCB design requirements are met. The PCB design analysis system 105 also tracks and/or determines whether the generated recommendations are followed and/or are changed (e.g., by an individual or an engineering team). Based on this determination, the PCB design analysis system 105 updates its knowledge base and can provide updated/additional recommendations based on any feedback (both positive and negative feedback) received and/or derived from the acceptance or rejection of the recommendations.

In an example, the PCB design analysis system 105 includes a learning system 110. The learning system 110 enables the PCB design analysis system 105 to receive and/or “learn” various PCB design rules, available tools and/or tooling features, approved and/or fabricated PCBs (and what tools/tooling features are used and/or are associated with various fabricated PCBs) and so on.

The PCB design analysis system 105 also includes an analysis system 115. In an example, the analysis system 115 analyzes the PCB design based on the various rules and/or other information received by the PCB design analysis system 105. When the PCB design has been analyzed, the analysis system 115 determines whether the PCB design satisfies various PCB design rules and/or whether a recommendation should be generated.

If the analysis system 115 determines a recommendation should be generated, the analysis system 115 provides its analysis (or information associated with its analysis) to a recommendation system 120. The recommendation system 120 uses the information to generate one or more recommendations based on various PCB design aspects.

In an example, the recommendation is associated with a first PCB design aspect. For example, the recommendation includes one or more modifications to the PCB design. In an example, the modifications include a modification or change to a layout of one or more traces or communication paths in the PCB design. In another example, the modification includes a modification to one or more electronic components in the PCB design. For example, the modification to the one or more electronic components includes, but is not limited to, modifying electronic component placement, electronic component size, electronic component type and/or the number of electronic components on the PCB. The modification may also include modification to circuitry layouts, keep out zones, testing zones and the like.

In an example, the PCB design analysis system 105 can also generate a tooling recipe for the PCB design. For example, the tooling recipe includes the type of tools and/or tooling features that can be used with the PCB when the PCB based on the PCB design is fabricated.

In another example, the recommendation is associated with a second PCB design aspect. For example, the recommendation includes one or more modifications to one or more tools or tooling features that will be used with the PCB based on the PCB design. In such an example, the recommendation also includes a determined budget or cost for modifying and/or creating a new tool or modified tooling feature as well as a timeframe (or lead time) required for the modification.

In yet another example, the recommendation is associated with the first PCB design aspect and the second PCB design aspect. For example, the recommendation includes a modification to the PCB design and a modification to one or more tooling features associated with the PCB design. Although specific examples are included, other modifications may be determined by the analysis system 115.

In an example, the analysis system 115 also bases its recommendations on one or more PCB design criterion. For example, the analysis system 115 is aware of, or has deadline/timing information, that indicates when the PCB design should be approved or finalized or whether the PCB design can be modified. In another example, the PCB design criterion includes a total cost allocated for any tooling changes or updates. Although specific PCB design criterion are mentioned, other PCB design criterion may be used.

When the recommendation system 120 has generated a recommendation, the recommendation is provided to a messaging system 125. The messaging system 125 provides the generated recommendation to a computing device. In an example, the recommendation is a text-based recommendation. In another example, the recommendation is a graphical recommendation. In yet another example, the recommendation is an illustration, an image or a series of illustrations/images. The recommendation can also include text and graphics/images. In another example, the recommendation includes audible instructions, visual presentations (e.g., a video) or combinations thereof.

In an example, the system 100 also includes a training system 130. In this example, the training system 130 is communicatively coupled to the PCB design analysis system 105 using a network 160. Although a network 160 is specifically shown and described, the training system 130 and the PCB design analysis system 105 may communicate with each other using any communication channel or protocol.

In an example, the training system 130 is used to teach or train the PCB design analysis system 105 about various PCB design rules the PCB design analysis system 105 needs to consider when analyzing a PCB design. The training system 130 also provides other information to the PCB design analysis system 105. In an example, this information includes, but is not limited to, PCB designs that have been approved and/or are currently in use, the type and/or features of one or more tools that may be used with the PCB when the PCB is fabricated, one or more desired features of the PCB design and so on.

For example, the training system 130 includes keep-out-zone keep-in-zone (KOZKIZ) rules 135. In an example, the KOZKIZ rules 135 include information that specifies areas on a PCB in which certain electronic components may or may not be placed based, at least in part, on various tooling requirements, safety and/or functionality. For example, the KOZKIZ rules 135 are used to determine whether an electronic component placed at a certain location on the PCB design will interfere with a tool or tooling feature that will be used, or otherwise associated with, the PCB design when the PCB is fabricated.

The training system 130 also includes mechanical keep out (MKO) rules 145. In an example, the MKO rules 145 specify areas on the PCB where physical components (e.g., electronic components) and/or mechanical structures are to be placed so as not to interfere with each other. For example, the MKO rules 145 specify that a mounting hole is to be provide at a certain location on the PCB so as to enable a mounting screw to be properly inserted into the mounting hole without interfering with electronic components or traces on the PCB.

In an example, the training system 130 also includes a PCB database 140. The PCB database 140 includes information about PCB designs that have been approved and/or fabricated using one or more available tools or tooling features in a tooling database 150.

The training system 130 also includes a tooling checklist 155. In an example, the tooling checklist 155 includes information regarding design rules and/or requirements for various components (electrical and/or mechanical components) on various PCBs (either PCBs in the PCB database 140 or PCBs that will be fabricated using the PCB design).

For example, the tooling checklist 155 includes information regarding rules or requirements of a pick and place fixture versus a bridging fixture. For example, the tooling checklist 155 indicates that guiding pins and/or a guiding feature of a bridging fixture cannot interfere with the pick and place feature during a pick and place process. The tooling checklist 155 also specifies that in order to follow this particular design rule and/or requirement, an 8 millimeter (mm) gap (or less) should be present between the bridging fixture surface and a drive surface.

In another example, the tooling checklist 155 includes design rules and/or requirements for the bridging fixture and a resting surface of the drive. For example, the design rules and/or requirements specifies that a drive resting surface or Z-datum should obey various standards to avoid pick and place fixture over press during conversion. Like the previous example, the tooling checklist 155 indicates that the usual practice to avoid this issue is to have 5.5 mm of space between a bridging fixture and a resting surface of the drive or Z-datum. Although specific examples are given, these are for example purposes only and the tooling checklist 155 may have any type of component information, design rules and requirements and/or practices to ensure the design rules and/or requirements are met.

In an example, the training system 130 provides one or more of the rules and/or other information to the PCB design analysis system 105 during an initial training or learning session. In an example, this information is shown as rules/information 165. Although an initial training or learning session is mentioned, it is also contemplated that the rules/information 165 provided by the training system 130 can be updated at any time and subsequently provided to the PCB design analysis system 105. For example, if the PCB database 140 and/or the tooling checklist 155 is updated (e.g., based on one or more recommendations generated by the PCB design analysis system 105 or by an engineering design team or individual), the training system 130 can provide the updated information to the PCB design analysis system 105. In another example, the learning system 110 of the PCB design analysis system 105 tracks changes to the various rules/information 165 in the system 100.

The various systems shown in FIG. 1 are presented as a combination of interdependent systems that interact to form an integrated whole. In an example, each system may be hardware components, software components or a combination thereof. In an example, the system 100 provides an operating environment for software components to execute and utilize resources or facilities of the system 100. In another example, the various systems are distributed across multiple computing devices.

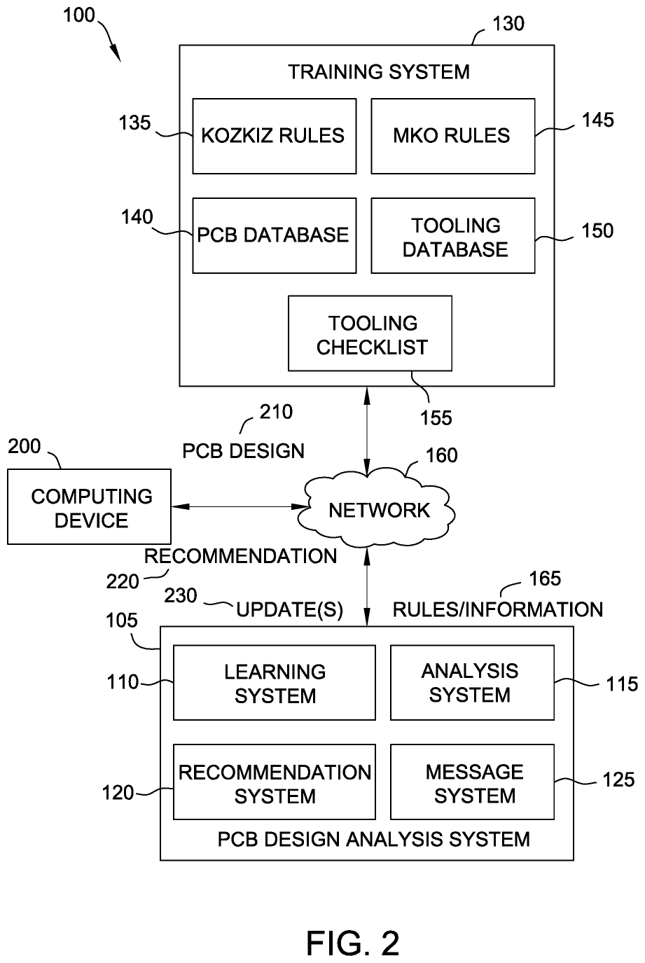

FIG. 2 illustrates the system 100 of FIG. 1 in which a computing device 200 has provided a PCB design 210 to the PCB design analysis system 105 according to an example. In an example, the computing device 200 is any computing device capable of providing the PCB design 210 to the PCB design analysis system 105. For example, the computing device 200 is a personal computer (PC), a mobile computing device and so on.

In the example shown, the computing device 200 is communicatively coupled to the PCB design analysis system 105 using the network 160. However, the computing device 200 may be communicatively coupled to the PCB design analysis system 105 using any communication channel or protocol. In an example, the computing device 200 is also communicatively coupled to the training system 130 via the network 160. In an example, the computing device 200 can provide updates 230 to the training system 130 and/or to the PCB design analysis system such as will be described in greater detail herein.

As previously indicated, the computing device 200 provides the PCB design 210 to the PCB design analysis system 105. The PCB design 210 is provided to the PCB design analysis system 105 in any suitable format or file type. For example, the PCB design 210 is a 3D file or format. In an example, the PCB design 210 also includes other information regarding, or otherwise associated with, the PCB design 210. For example, the PCB design 210 includes information regarding an expected deliverable or deadline regarding a finalization of the PCB design 210. In another example, the information includes a budget regarding any potential tooling modifications. In another example, the information includes information about previously received accepted or rejected modifications to the PCB design 210. As such, the PCB design analysis system 105 can use the PCB design to further enhance its knowledge base and analysis. Although specific examples are given, other types of information may be provided to the PCB design analysis system 105 as part of the PCB design 210.

Upon receiving the PCB design 210, the PCB design analysis system 105 provides the PCB design 210 to the analysis system 115. The analysis system 115 analyzes the PCB design 210 (and the additional information) using the rules/information 165 such as previously described. In an example, the analysis system 115 also determines one or more PCB design criterion associated with the PCB design 210.

When the analysis is complete, the analysis system 115 provides the information associated with the analysis to the recommendation system 120. The recommendation system 120 generates a recommendation 220 based on the analysis. The recommendation 220 is then provided to the messaging system 125 and the messaging system 125 provides the recommendation 220 (e.g., via the network 160) to the computing device 200.

In an example, the analysis system 115 determines whether the PCB design 210 adheres to the various rules/information 165 the PCB design analysis system 105 has been taught. For example, the analysis system 115 compares the PCB design 210 to the MKO rules 145 and/or performs a tooling reusability study using the tooling database 150 and/or the tooling checklist 155. The analysis system 115 also analyzes the PCB design 210 in light of the KOZKIZ rules 135. Based on this analysis, the analysis system 115 may propose modifications to the PCB design 210 or generate tooling modification costs and timing. The analysis system 115 also updates the KOZKIZ rules 135 and/or the MKO rules 145 based on its analysis.

If the analysis system determines the PCB design 210 adheres to the rules/information 165, the analysis system 115, the PCB design 210 is approved. As such, the recommendation system 120 generates a recommendation 220 that indicates the PCB design 210 is approved. In such an example, the recommendation 220 includes a tooling recipe that indicates one or more tools or tooling features (e.g., from the tooling database 150) that can be used with the PCB that will be fabricated using the PCB design 210.

In another example, the analysis system 115 determines that the PCB design 210 should be modified. In such an example, the recommendation 220 generated by the recommendation system 120 includes the proposed modification. In an example, the recommendation 220 also includes a tooling recipe that specifies various tools and/or tooling features that can be used with the PCB when the PCB is fabricated.

In yet another example, the analysis system 115 determines that one or more tools or tooling features should be modified. As such, the recommendation 220 indicates that one or more tools or tooling features should be modified. For example, the analysis system 115 determines, based on one or more PCB design criterion (e.g., an expected deliverable date or information), that the PCB design cannot be modified. As a result, the recommendation system 120 generates the recommendation 220 that one or more tools or tooling features be modified. In an example, the recommendation 220 includes a lead time for the modification and/or an estimated cost for the modification.

In an example, and regardless of the recommendation 220 that is generated, the PCB design analysis system 105 receives updates 230 regarding whether the recommendation 220 was followed or changed. For example, the learning system 110 of the PCB design analysis system 105 uses the updates 230 to continue to learn which solutions or recommendations are accepted by an individual or engineering team or whether the recommendation was rejected or modified. The updates 230 may also include information as to why the recommendation was rejected, modified or accepted. This information is used to improve the recommendations that are generated. In another example, the updates 230 includes updates to the rules/information 165 associated with the training system 130.

In yet another example, the updates 230 are provided to the training system 130. For example, if a PCB design 210 is approved, the approved PCB design 210 is added to the PCB database 140. In yet another example, the PCB design analysis system 105 updates the rules/information 165 stored in the training system 130. For example, when a modification is made to a tool or tooling feature, the PCB design analysis system 105 updates MKO rules 145 and/or KOZKIZ rules 135 based on the modification.

In another example, the recommendation 220 includes a combination of the recommendations described above. For example, the recommendation 220 indicates a modification to the PCB design 210 and a modification to one or more tools or tooling features. In an example, the recommendation 220 is based, at least in part, on one or more PCB design criterion.

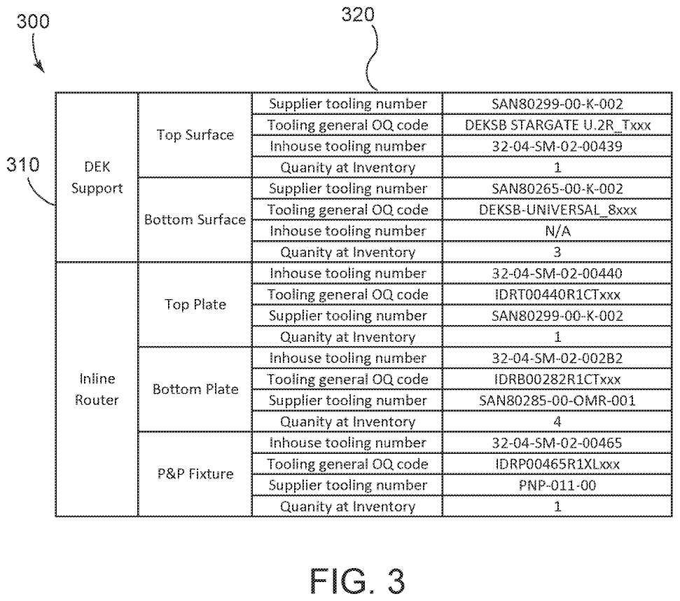

FIG. 3 illustrates a tooling recipe 300 that is generated by a PCB design analysis system according to an example. In an example, the tooling recipe 300 is generated by the PCB design analysis system 105 shown and described with respect to FIG. 1 and FIG. 2. In an example, the tooling recipe 300 is included as part of a recommendation that is generated by the PCB design analysis system and provided to a computing device. For example, the tooling recipe 300 is generated when a PCB design is modified. In another example, the tooling recipe 300 is generated when a PCB design is accepted.

In this example, the tooling recipe 300 includes an identification 310 of one or more tools or tooling features that may be used with a PCB in a PCB design that is analyzed by the PCB design analysis system. The tooling recipe 300 also includes other identifying information 320 about the one or more tools such as, for example, a tooling number, a the number of tools available, a surface or structure on which the tool is to be used and so on.

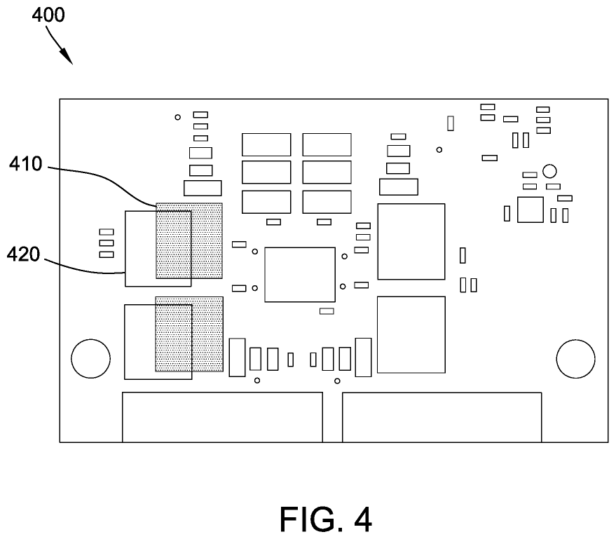

FIG. 4 illustrates a PCB design modification 400 that is included with a recommendation generated by a PCB design analysis system according to an example. In an example, the PCB design modification 400, along with the associated recommendation, is generated by the PCB design analysis system 105 shown and described with respect to FIG. 1 and FIG. 2.

In this example, the PCB design analysis system received a PCB design (e.g., PCB design 210 (FIG. 2)). The PCB design analysis system determined, based on one or more design criterion and/or on various rules and information (e.g., rules/information 165 (FIG. 1)), that a current placement of an electronic component 410 in the original PCB design should be moved in order to satisfy the various rules/information known by the PCB design analysis system.

As a result, the PCB design analysis system generates a recommendation, including the design modification 400, in which the electronic component 410 is moved from a first location (e.g., its current location) to a second location on the PCB (indicated by the reference number 420). In an example and as previously discussed, when the PCB design modification 400 is generated, the PCB design modification, along with a tooling recipe (e.g., tooling recipe 300 (FIG. 3)) is provided to a computing device and/or a training system associated with the PCB design analysis system.

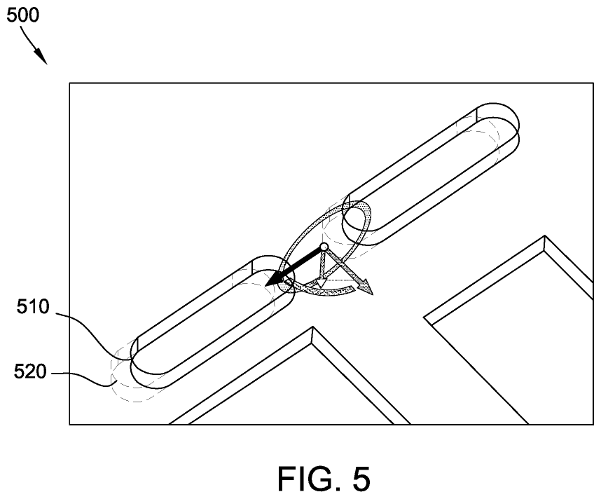

FIG. 5 illustrates a tooling modification 500 that is included with a recommendation generated by a PCB design analysis system according to an example. In an example, the tooling modification 500, along with the associated recommendation, is generated by the PCB design analysis system 105 shown and described with respect to FIG. 1 and FIG. 2.

In this example, the PCB design analysis system received a PCB design (e.g., PCB design 210 (FIG. 2)). The PCB design analysis system determined, based on one or more design criterion and/or on various rules and information (e.g., rules/information 165 (FIG. 1)), that one or more tools or tooling features should be modified in order to satisfy the various rules and/or information known by the PCB design analysis system.

As a result, the PCB design analysis system generates a recommendation, including the tooling modification 500, that causes an aperture 510 to be formed in a second location (indicated by the reference number 520) instead of the first location at which the aperture 510 is positioned. In an example, when the tooling feature is modified, the PCB design analysis system updates one or more rules and/or information associated with the modified tooling feature. Additionally, the PCB design analysis system may also generate a lead time and/or associated costs that may be needed to complete the tooling modification. In an example, once this information is generated and/or determined, the information, along with the tooling modification 500, is provided to a computing device and/or a training system associated with the PCB design analysis system.

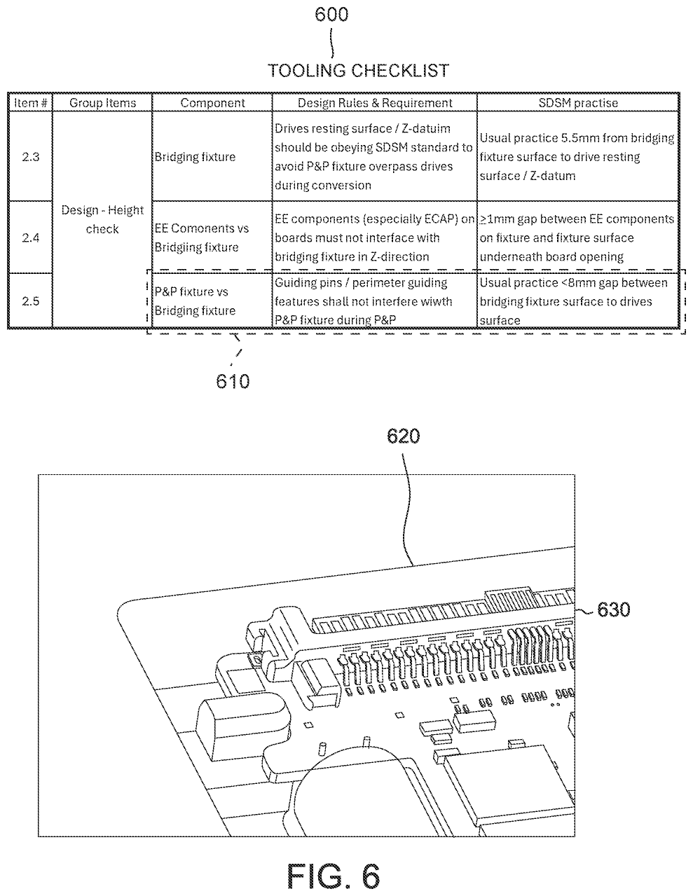

FIG. 6 illustrates how a PCB design analysis system uses information 610 in a tooling checklist 600 to determine whether a PCB design is to be modified according to an example. In an example, the PCB design analysis system that uses the information 610 in the tooling checklist 600 is similar to the PCB design analysis system 105 shown and described with respect to FIG. 1 and FIG. 2.

In the example shown, the PCB design provided to the PCB design analysis system includes information corresponding to a PCB 630 and an associated tool or tooling feature 620 (e.g., from the tooling database 150 (FIG. 1)). The PCB design analysis system determines, based on its known or learned rules and/or information, whether the combination of the PCB 630 and the tooling feature 620 satisfies the information 610 or the rule specified by the tooling checklist 600.

For example, the information 610 in the tooling checklist 600 specifies that a gap of less than an 8 mm be present between a bridging feature and a drive surface. As shown in FIG. 6, a gap of 3.9 mm is present between the PCB 630 and the tooling feature 620. As such, the PCB design analysis system determines that the tooling checklist 600 is satisfied.

In such an example, the PCB design analysis system generates a recommendation that indicates this particular PCB design does not need to be modified. The recommendation is then provided to a computing device. In addition, the PCB design analysis system also generates a tooling recipe based, at least in part, on the combination. When generated, the tooling recipe is stored by the PCB design analysis system and/or an associated training system. For example, the tooling recipe is stored in the tooling database 150 of the training system 130 shown and described with respect to FIG. 1 and FIG. 2.

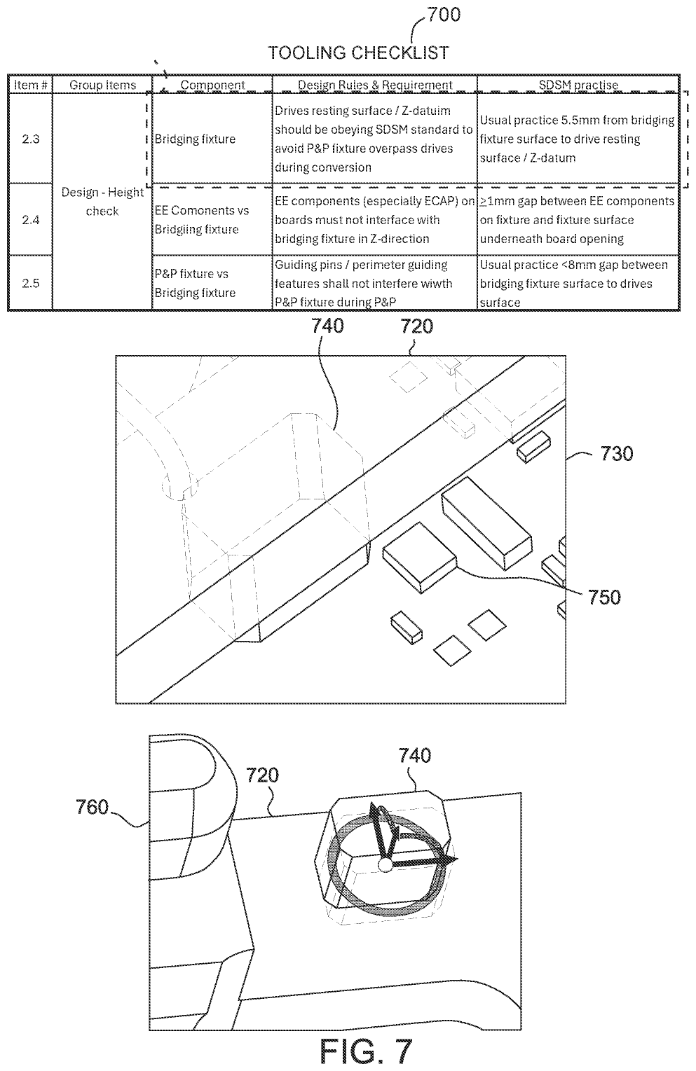

FIG. 7 illustrates how a PCB design analysis system uses information 710 in a tooling checklist 700 to determine whether a PCB design is to be modified according to another example. In an example, the PCB design analysis system that uses the information 710 in the tooling checklist 700 is similar to the PCB design analysis system 105 shown and described with respect to FIG. 1 and FIG. 2.

In the example shown, the PCB design provided to the PCB design analysis system includes information corresponding to a PCB 730 and an associated tool 720 and/or tooling feature 740. The PCB design analysis system determines, based on its information, whether the combination of the PCB 730 and the tool 720 satisfies the information 710 or the rule specified by the tooling checklist 700.

In this example, the information 710 in the tooling checklist 700 specifies that a drive resting surface or Z-datum should obey certain standards to avoid pick and place fixture over press during conversion. To avoid this, the tooling checklist 700 indicates that a 5.5 mm space be provided between the tooling feature 740 and an electronic component 750 on the PCB 730. However, as shown in FIG. 7, the space between the tooling feature 740 and the electronic component 750 is only 0.45 mm. Thus, the PCB design analysis system determines that the information 710 specified by the tooling checklist 700 is not satisfied.

In an example, the PCB design analysis system also determines, based on information provided by or otherwise associated with the PCB design, that one or more PCB design criterion will not be met if the PCB is modified. For example, the PCB design analysis system determines that due to time constraints, the PCB design cannot be modified. As a result, the PCB design analysis system determines that the tooling feature 740 should be moved.

When this determination is made, the PCB analysis system generates a recommendation and provides the recommendation to the computing device. In this example, the recommendation includes a modification 760 to the tooling feature 740. In an example, the recommendation also includes associated costs and/or a lead time associated with the proposed modification 760.

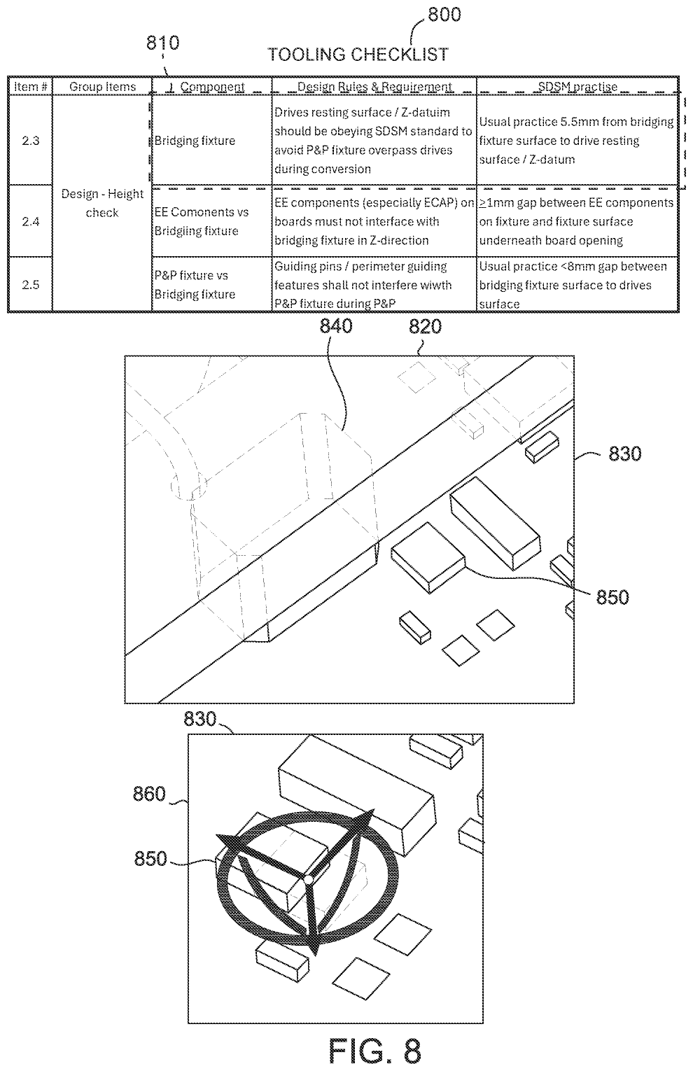

FIG. 8 illustrates how a PCB design analysis system uses information 810 in a tooling checklist 800 to determine whether a PCB design is to be modified according to yet another example. In an example, the PCB design analysis system that uses the information 810 in the tooling checklist 800 is similar to the PCB design analysis system 105 shown and described with respect to FIG. 1 and FIG. 2.

The example shown in FIG. 8 is similar to the example shown in FIG. 7. However, in this example, the PCB design analysis system determines, based on information provided by or otherwise associated with the PCB design, that the PCB design can be modified. As such, the PCB design analysis system generates a recommendation 860 that the electronic component 850 on the PCB 830 be moved as shown in FIG. 8.

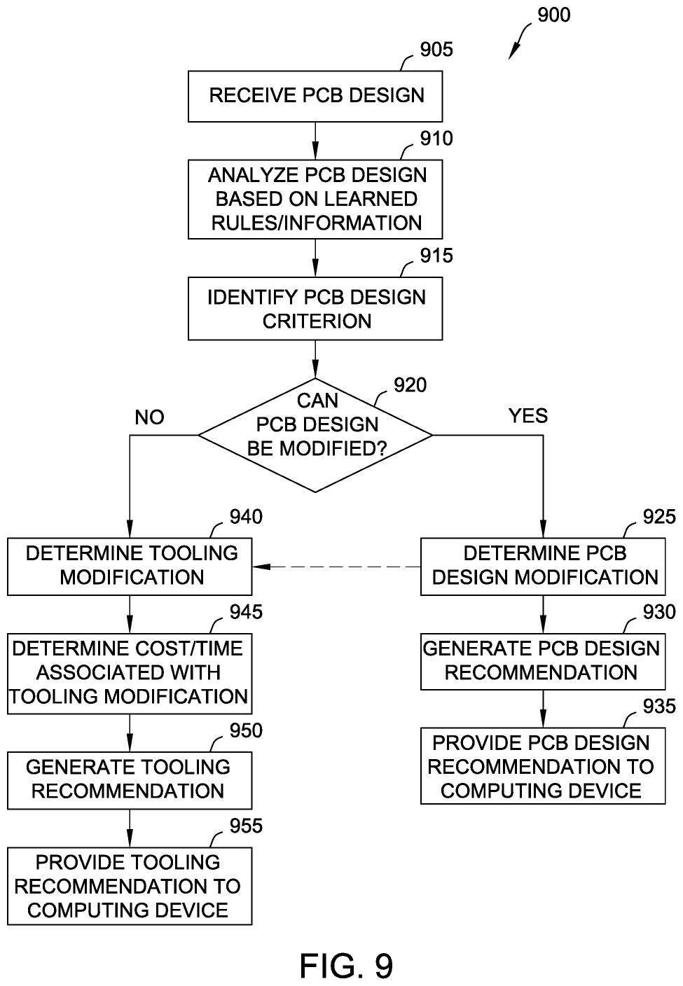

FIG. 9 illustrates a method 900 for generating a PCB design recommendation according to an example. In an example, the method 900 is performed by a PCB design analysis system, such as, for example, the PCB design analysis system 105 shown and described with respect to FIG. 1 and FIG. 2.

In an example, the method 900 begins when a PCB design is received (905) by the PCB design analysis system. Based on receiving the PCB design, the PCB design analysis system analyzes (910) the PCB design based on learned rules/information. For example, the PCB design analysis system uses artificial intelligence, machine learning and/or a knowledge base to determine whether a layout and/or components in the PCB design satisfy various rules and/or information learned or known by the PCB design analysis system.

For example, the PCB design analysis system compares the PCB design to known or learned MKO rules. The PCB design analysis system may also perform a tooling reusability study using learned or known tooling information. In another example, the PCB design analysis system also analyzes the PCB design in light of known or learned KOZKIZ rules.

The PCB design analysis system also identifies (915) PCB design criterion. In an example, the PCB design criterion includes information regarding whether the PCB design can be modified. In another example, the PCB design criterion includes cost and/or time constraints for modifying the PCB and/or modifying tools or tooling features based on the PCB design. Although specific PCB design criterion are mentioned, other PCB design criterion may be used.

The PCB design analysis system then determines (920), based on the rules/information analysis and/or the PCB design criterion, whether the PCB design can be modified. If the PCB design analysis system determines the PCB design can be modified, the PCB design analysis system determines (925) one or more modifications to the PCB design. In an example, the PCB design modifications include, but are not limited to modifications to electronic component placement, modifications to an electronic component size, modifications to an electronic component type and/or the number of electronic components provide on the PCB. In another example, the modification relates to a keep-out area or a testing area on the PCB. In another example, the modifications include modifications to one or more communication paths (e.g., traces and vias) on the PCB.

When the modification is determined, the PCB design analysis system generates (930) a PCB design recommendation. The PCB design recommendation is then provided (935) to a computing device.

However, if it is determined (920), based on the PCB design criterion, that the PCB design cannot be modified, the PCB design analysis system determines (940) a tooling modification to one or more tools or tooling features that can be used with the PCB in the PCB design. As part of this process, the PCB design analysis system also determines (945) costs and/or an amount of time that may be needed to complete the tooling modification.

Using this information, the PCB design analysis system generates (930) a tooling recommendation. The tooling recommendation is provided (955) to the computing device.

In another example, the PCB design analysis system determines (920) that the PCB design is modifiable. Additionally, the PCB design analysis system also determines that one or more tools or tooling features can or should be modified based, at least in part, on the PCB design modification. In such examples, the PCB design analysis system determines (925) a PCB design modification and determines (940) a tooling modification. In an example, the determination of the modification to the PCB design and the tooling modification occurs simultaneously, substantially simultaneously (e.g., a time at which the tooling modification is being determined/generated at least partially overlaps a time at which the PCB modification is being determined/generated) or sequentially. The remaining operations (e.g., operations 945, 950, 955, 930 and 935) may also occur simultaneously, substantially simultaneously or sequentially.

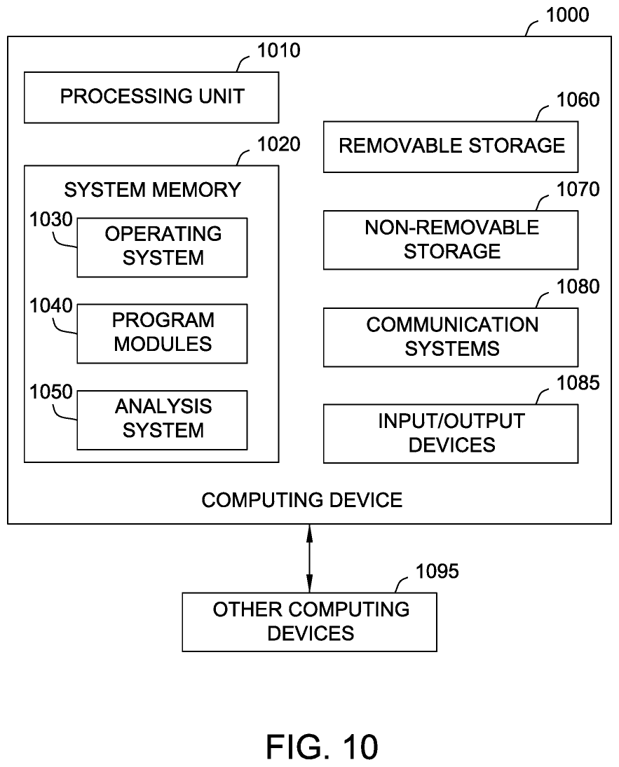

FIG. 10 is a system diagram of a computing device 1000 according to an example. The computing device 1000, or various components and systems of the computing device 1000, may be integrated or associated with a PCB design analysis system (e.g., the PCB design analysis system 105 (FIG. 1)), a training system (e.g., the training system 130 (FIG. 1)) and/or the computing device 200 shown and described with respect to FIG. 2.

As shown in FIG. 10, the physical components (e.g., hardware) of the computing device are illustrated and these physical components may be used to practice the various aspects of the present disclosure. In addition to the various components shown in FIG. 10, the computing device 1000 may also include, or otherwise be associated with, the various systems, information, databases and/or rules shown and described herein.

The computing device 1000 includes at least one processing unit 1010 and a system memory 1020. The system memory 1020 includes, but is not limited to, volatile storage (e.g., random access memory), non-volatile storage (e.g., read-only memory), flash memory, or any combination of such memories. The system memory 1020 may also include an operating system 1030 that controls the operation of the computing device 1000 and one or more program modules 1040. In an example, the program modules 1040 are responsible for executing one or more operations and/or the analysis described herein. The program modules 1040 may also communicate recommendation system and/or an analysis system 1050 that performs some or all of the various processes described herein.

The computing device 1000 may also have additional features or functionality. For example, the computing device 1000 may include additional data storage devices (e.g., removable and/or non-removable storage devices) such as, for example, magnetic disks, optical disks, tape, solid-state storage, flash storage and the like. These additional storage devices are labeled as a removable storage 1060 and a non-removable storage 1070.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 10 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 1000 on the single integrated circuit (chip). The disclosure may also be practiced using other technologies capable of performing logical operations such as, for example, AND, OR, and NOT, including but not limited to, mechanical, optical, fluidic, and quantum technologies.

The computing device 1000 may include one or more communication systems 1080 that enable the computing device 1000 to communicate with other computing devices 1095 or systems. Examples of communication systems 1080 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 1000 may also have one or more input devices and/or one or more output devices shown as input/output devices 1085. These input/output devices 1085 may include a keyboard, a sound or voice input device, haptic devices, a touch, force and/or swipe input device, a display, speakers, etc. The aforementioned devices are examples and others may be used.

The system memory 1020, the removable storage 1060, and the non-removable storage 1070 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1000. Any such computer storage media may be part of the computing device 1000.

In accordance with the above, examples of the present disclosure describe a method performed by a PCB design analysis system, comprising: receiving a printed circuit board (PCB) design information; analyzing the PCB design information using the PCB design analysis system, the PCB design analysis system being trained using one or more PCB design rules; determining, using the PCB design analysis system, based at least in part, on the analysis, whether to provide a recommendation regarding an update to the PCB design; based, at least in part, on determining to provide the recommendation regarding the update to the PCB design, the PCB design analysis system determining whether to provide a first recommendation corresponding to a first PCB design aspect or to provide a second recommendation corresponding to a second PCB design aspect, wherein the determination as to whether to provide the first recommendation or the second recommendation is based, at least in part, on a PCB design criterion; generating, by the PCB design analysis system, at least one of the first recommendation and the second recommendation; and providing, by the PCB design analysis system, the at least one of the first recommendation and the second recommendation to a computing device. In an example, the one or more PCB design rules include at least one of: mechanical keep out (MKO) rules; keep out zone keep in zone (KOZKIZ) rules; and tooling design information. In an example, the first recommendation is a modification to the PCB design information. In an example, the first recommendation includes a tooling recipe associated with the modification of the PCB design information. In an example, the second recommendation is a tooling modification to one or more tooling features used to fabricate a PCB based on the PCB design information. In an example, the second recommendation includes a determined amount of time for modifying the one or more tooling features. In an example, the second recommendation includes a determined cost for modifying the one or more tooling features. In an example, the PCB design criterion is based, at least in part, on a timing schedule. In an example, the PCB design criterion is based, at least in part, on a determined cost associated with the second recommendation.

Other examples describe a printed circuit board (PCB) design analysis system, comprising: at least one processor; and a memory communicatively coupled to the processor and storing instructions that, when executed by the processor, perform operations, comprising: receiving a PCB design; analyzing the PCB design using one or more learned PCB design rules; determining, based at least in part, on the analysis and on a PCB design criterion, whether to provide a first recommendation corresponding to a first PCB design aspect or to provide a second recommendation corresponding to a second PCB design aspect; generating at least one of the first recommendation and the second recommendation; and providing the at least one of the first recommendation and the second recommendation to a computing device. In an example, the one or more PCB design rules include at least one of: mechanical keep out (MKO) rules; keep out zone keep in zone (KOZKIZ) rules; and tooling design information. In an example, the first recommendation includes a PCB design modification. In an example, the first recommendation includes a tooling recipe associated with the PCB design modification. In an example, the operations further comprise: receiving feedback associated with the at least one of the first recommendation and the second recommendation; and updating an analysis system associated with the PCB design analysis system based, at least in part, on the feedback. In an example, the second recommendation includes a determined amount of time for modifying the one or more tooling features. In an example, the PCB design criterion is based, at least in part, on a timing schedule.

Additional examples describe a system, comprising: at least one processing means; and a printed circuit board (PCB) design analysis means operable to: receive, from a computing device, a PCB design; analyze the PCB design using one or more learned PCB design rules; determine, based at least in part, on the analysis and on a PCB design criterion, whether to provide a first recommendation corresponding to a first PCB design aspect or to provide a second recommendation corresponding to a second PCB design aspect; generate at least one of the first recommendation and the second recommendation; and provide the at least one of the first recommendation and the second recommendation to the computing device. In an example, the system also includes means for receiving feedback associated with the at least one of the first recommendation and the second recommendation; and means for updating a knowledge base associated with the PCB design analysis means using the feedback. In an example, the first recommendation includes a PCB design modification. In an example, the second recommendation is a tooling modification to one or more tooling features used to fabricate a PCB based on the PCB design.

The description and illustration of one or more aspects provided in the present disclosure are not intended to limit or restrict the scope of the disclosure in any way. The aspects, examples, and details provided in this disclosure are considered sufficient to convey possession and enable others to make and use the best mode of claimed disclosure.

The claimed disclosure should not be construed as being limited to any aspect, example, or detail provided in this disclosure. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Aspects of the present disclosure have been described above with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks. Additionally, it is contemplated that the flowcharts and/or aspects of the flowcharts may be combined and/or performed in any order.

References to an element herein using a designation such as “first,” “second,” and so forth does not generally limit the quantity or order of those elements. Rather, these designations may be used as a method of distinguishing between two or more elements or instances of an element. Thus, reference to first and second elements does not mean that only two elements may be used or that the first element precedes the second element. Additionally, unless otherwise stated, a set of elements may include one or more elements.

Terminology in the form of “at least one of A, B, or C” or “A, B, C, or any combination thereof” used in the description or the claims means “A or B or C or any combination of these elements.” For example, this terminology may include A, or B, or C, or A and B, or A and C, or A and B and C, or 2A, or 2B, or 2C, or 2A and B, and so on. As an additional example, “at least one of: A, B, or C” is intended to cover A, B, C, A-B, A-C, B-C, and A-B-C, as well as multiples of the same members. Likewise, “at least one of: A, B, and C” is intended to cover A, B, C, A-B, A-C, B-C, and A-B-C, as well as multiples of the same members.

Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

What is claimed is:

1. A method performed by a PCB design analysis system, comprising:
receiving a printed circuit board (PCB) design information;
analyzing the PCB design information using the PCB design analysis system, the PCB design analysis system being trained using one or more PCB design rules;
determining, using the PCB design analysis system, based at least in part, on the analysis, whether to provide a recommendation regarding an update to the PCB design;
based, at least in part, on determining to provide the recommendation regarding the update to the PCB design, the PCB design analysis system determining whether to provide a first recommendation corresponding to a first PCB design aspect or to provide a second recommendation corresponding to a second PCB design aspect, wherein the determination as to whether to provide the first recommendation or the second recommendation is based, at least in part, on a PCB design criterion;
generating, by the PCB design analysis system, at least one of the first recommendation and the second recommendation; and
providing, by the PCB design analysis system, the at least one of the first recommendation and the second recommendation to a computing device.

2. The method of claim 1, wherein the one or more PCB design rules include at least one of:
mechanical keep out (MKO) rules;
keep out zone keep in zone (KOZKIZ) rules; and
tooling design information.

3. The method of claim 1, wherein the first recommendation is a modification to the PCB design information.

4. The method of claim 3, wherein the first recommendation includes a tooling recipe associated with the modification of the PCB design information.

5. The method of claim 1, wherein the second recommendation is a tooling modification to one or more tooling features used to fabricate a PCB based on the PCB design information.

6. The method of claim 5, wherein the second recommendation includes a determined amount of time for modifying the one or more tooling features.

7. The method of claim 5, wherein the second recommendation includes a determined cost for modifying the one or more tooling features.

8. The method of claim 1, wherein the PCB design criterion is based, at least in part, on a timing schedule.

9. The method of claim 1, wherein the PCB design criterion is based, at least in part, on a determined cost associated with the second recommendation.

10. A printed circuit board (PCB) design analysis system, comprising:
at least one processor; and
a memory communicatively coupled to the processor and storing instructions that, when executed by the processor, perform operations, comprising:
receiving a PCB design;
analyzing the PCB design using one or more learned PCB design rules;
determining, based at least in part, on the analysis and on a PCB design criterion, whether to provide a first recommendation corresponding to a first PCB design aspect or to provide a second recommendation corresponding to a second PCB design aspect;
generating at least one of the first recommendation and the second recommendation; and
providing the at least one of the first recommendation and the second recommendation to a computing device.

11. The PCB design analysis system of claim 10, wherein the one or more PCB design rules include at least one of:
mechanical keep out (MKO) rules;
keep out zone keep in zone (KOZKIZ) rules; and
tooling design information.

12. The PCB design analysis system of claim 10, wherein the first recommendation includes a PCB design modification.

13. The PCB design analysis system of claim 12, wherein the first recommendation includes a tooling recipe associated with the PCB design modification.

14. The PCB design analysis system of claim 10, wherein the operations further comprise:
receiving feedback associated with the at least one of the first recommendation and the second recommendation; and
updating an analysis system associated with the PCB design analysis system based, at least in part, on the feedback.

15. The PCB design analysis system of claim 14, wherein the second recommendation includes a determined amount of time for modifying the one or more tooling features.

16. The PCB design analysis system of claim 10, wherein the PCB design criterion is based, at least in part, on a timing schedule.

17. A system, comprising:
at least one processing means; and
a printed circuit board (PCB) design analysis means operable to:
receive, from a computing device, a PCB design;
analyze the PCB design using one or more learned PCB design rules;
determine, based at least in part, on the analysis and on a PCB design criterion, whether to provide a first recommendation corresponding to a first PCB design aspect or to provide a second recommendation corresponding to a second PCB design aspect;
generate at least one of the first recommendation and the second recommendation; and
provide the at least one of the first recommendation and the second recommendation to the computing device.

18. The system of claim 17, further comprising:
means for receiving feedback associated with the at least one of the first recommendation and the second recommendation; and
means for updating a knowledge base associated with the PCB design analysis means using the feedback.

19. The system of claim 17, wherein the first recommendation includes a PCB design modification.

20. The system of claim 17, wherein the second recommendation is a tooling modification to one or more tooling features used to fabricate a PCB based on the PCB design.
